(19) United States
(12) Patent Application Publication
(10) Pub. No.: US 2020/0071013 A1
(43) Pub. Date: Mar. 5, 2020

(54) METHOD FOR PACKAGING PRODUCTS AND THERMOFORMING PACKAGING MACHINE

(71) Applicant: Multivac Sepp Haggenmüller SE & Co. KG, Wolfertschwenden (DE)

(72) Inventors: Konrad MÖßNANG, Kempten (DE); Martin HAGGENMÜLLER, Kempten (DE)

(21) Appl. No.: 16/554,533

(22) Filed: Aug. 28, 2019

(30) Foreign Application Priority Data
Aug. 29, 2018 (DE) 10 2018 214 666.7

(51) Int. Cl. B65B 61/06; B29C 65/78; B29C 65/00; B65B 47/02; B65B 61/02; B65B 51/00

(52) U.S. Cl. CPC B65B 61/065; B29C 65/7802; B65B 51/00; B65B 47/02; B65B 61/02; B29C 66/849

(57) ABSTRACT

A packaging machine that includes a base film being conveyed in a clocked manner using a conveying device along a direction of transport to a forming station. The film is further conveyed to a loading path, onward to a sealing station and again onward to a cutting station. Packaging troughs are formed into the base film in the forming station by thermoforming. The packaging troughs are filled with products in the loading path. The filled packaging troughs are sealed by sealingly connecting a top film to the base film in the sealing station. The filled packaging troughs are cut out from the film composite in the cutting station. Centering holes are formed in the base film in a defined relative position to the packaging troughs, and the base film is aligned by engagement of at least one centering pin into the centering holes.

### CROSS-REFERENCE TO RELATED APPLICATIONS

This Application claims priority to German Patent Application No. 10 2018 214 666.7 filed on Aug. 29, 2018 to Konrad Möβnang and Martin Haggenmüller, currently pending, the entire disclosure of which is incorporated herein by reference.

### FIELD OF THE INVENTION

The present invention relates to packaging products in thermoforming packaging machines.

### BACKGROUND OF THE INVENTION

In thermoforming packaging machines known from practice, a base film web is fed by way of a conveying device successively to a forming station, a loading path, a sealing station and a cutting station. In the forming station, packaging troughs are formed in the base film web by thermoforming. The packaging troughs are filled in the loading path with products to be packaged. The filled packaging troughs are closed in the sealing station by sealing a top film thereonto. The sealed packagings are finally cut out from the film composite in the cutting station. Products of all kinds can be packaged in thermoforming packaging machines. Thermoforming packaging machines are particularly relevant, for example, for packaging food products or medical technology products.

A packaging machine for packaging objects in blister packaging is known from DE 10 2006 045 292 A1. In order to facilitate assembly of the packaging machine at the assembly site, the packaging machine is separated into individual modules, each having their own drives for the base film. Such a module comprises, for example, a forming station for forming bowls into the base film web. In addition, modules are provided with a filling station for supplying products, with a sealing station for closing the packaging, and with a punching and cutting device. To synchronize the working cycle of the individual modules to each other, compensation loops are provided which provide for constant tensioning of the base film web at certain locations.

Packaging produced in thermoforming packaging machines typically have a circumferential flange region which comprises, inter alia, the sealing seam (connection between packaging trough and top film). In principle, it would be desirable for some applications to form the flange as narrow as possible However, this can be problematic, since tolerances for positioning the sealing seam and tolerances for the process of cutting out the sealed packaging from the film composite must lie within the flange area.

From EP 2 740 679 A1, a thermoforming packaging machine is known in which not only the packaging troughs are formed in the forming station, but holes are also introduced into the packaging troughs at a defined location by use of a punching device. These holes serve as reference elements and are each detected by way of a measuring system, such as a light barrier, before arriving at the sealing station and the cutting station. The sealing station and the cutting station are movable along the direction of film transportation by an adjustment device and are each suitably aligned in a clocked manner relative to the packaging troughs to be processed based on a location of the holes detected. The sealing station and the cutting station can then always be positioned relatively accurately relative to the position of the packaging troughs so that transport tolerances are at least in part compensated for and packaging with relatively small flanges can be produced. One disadvantage of this system is that the sealing station and the cutting station must be formed to be adjustably movable in order to be able to be aligned relative to the base film. In addition, a separate measuring sys-tem for detecting the holes is required.

### SUMMARY OF THE INVENTION

It is an object of the invention to find a way to produce packaging with a small flange width in thermoforming packaging machines in a reproducible manner with as little effort as possible and reliably.

The invention relates to a method for packaging products, wherein, for example, food products or medicine technology products can be packaged. The method comprises the clocked (intermittent) conveyance with a conveying device of a base film along a direction of transport to a forming station, onwards to a loading path, further onward to a sealing station and still further onward to a cutting station. Packaging troughs may be formed into the base film in the forming station by thermoforming. In the loading path, the packaging troughs may be filled with products. This can be done, for example, manually or automatically. The filled packaging troughs may be sealed in the sealing station by sealingly connecting a top film to the base film. The sealing can optionally be carried out under vacuum or inert gas atmosphere. This is useful, for example, if the shelf life of food products to be packaged is to be increased. In the cutting station, the filled packaging troughs may be cut out from the film composite. This can be done, for example, by completely cutting, in particular punching out, the base film and the top film along the packaging outline.

According to the invention, centering holes may be formed in the base film in defined relative positions to the packaging troughs. The base film may be then aligned by engagement of at least one centering pin into the centering holes. The base film can be moved for alignment by the engagement of the centering pin into a corresponding centering hole. The movement of the base film during alignment can comprise shifting the position of the base film and/or a change in the shape of the base film by stretching it. In particular, the base film can be aligned by the engagement between the centering pin and the centering hole along the direction of transport and/or along a transverse direction extending perpendicular to the direction of transport, i.e. perform a motion during the alignment along (or in the opposite direction of) the direction of transport and/or transversely to the direction of transport. The alignment can take place in particular in a horizontal plane.

By aligning the base film, deviations and inaccuracies in the clocked conveyance of the base film by the conveying device may be compensated for. The advance tolerance during the clocked conveyance of the base film can therefore be significantly reduced. Positioning of the pack-aging troughs formed into the base film relative to different processing stations can therefore be set very accurately. Due to the processing accuracy thus increased, it becomes possible, for example, to produce packaging having a narrower flange, since the tolerance region to be covered by the flange may be reduced. Overall, the production of packaging becomes more accurate and more reproducible.

The alignment of the base film by the mechanical engagement of the centering pin into a corresponding centering hole may be particularly inexpensive and easy to implement. It is not necessary to provide a separate device for detecting the centering hole. Since, according to the invention, the base film and not the corresponding workstation may be aligned, it is not necessary that the workstation be movably adjustable. For example, the workstations can simply be attached in a stationary manner to a machine frame of the packaging machine.

The at least one centering pin preferably comprises at least one centering pin provided in the cutting station. By aligning the base film in the cutting station, the packaging troughs can be positioned directly prior to being cut out from the film composite. This ensures that the cut may be made as accurately as possible along the desired packaging outline.

A cutting tool upper part and a cutting tool lower part of the cutting station can perform a relative motion towards each other for cutting out the filled packaging troughs. The engagement of the at least one centering pin into a corresponding centering hole may be preferably effected in the course of this relative motion such that the base film may be aligned prior to the actual cutting action in the cutting station.

The centering pin can be provided in particular on the cutting tool upper part or the cutting tool lower part. The centering pin can then engage into the corresponding centering hole in the course of the relative motion between the cutting tool upper part and the cutting tool lower part without additional measures, in particular without its own drive device.

Alternatively or in addition to a centering pin provided in the cutting station, the at least one centering pin can comprise at least one centering pin provided in the sealing station. That centering pin can align the base film directly prior to the top film being sealed on, so that the accuracy in positioning the sealing seam relative to the packaging trough may be increased.

For the sealing connection of the top film to the base film, a sealing tool upper part and a sealing tool lower part of the sealing station can perform a relative motion toward one another. The engagement of the at least one centering pin into a corresponding centering hole provided in the sealing station may be preferably effected in the course of this relative motion such that the base film is aligned prior to the actual sealing action in the sealing station.

The centering pin can, in particular, be attached to the sealing tool upper part or the sealing tool lower part and come into engagement with a corresponding centering hole during the relative motion between the sealing tool upper part and the sealing tool lower part without additional measures, in particular without any additional drive device.

According to an advantageous embodiment, the centering holes may be formed when the pack-aging troughs are formed in the forming station. This can be done, in particular, by punching out the centering holes. A respective punching device could, for example, be integrated into the forming station such that a drive of the forming station used for thermoforming the pack-aging troughs may be also used for punching. Alternatively, it would also be conceivable to provide a separate punching station for forming the centering holes. When the centering holes are formed in the forming station, the defined relative position of the centering holes to the pack-aging troughs can be obtained particularly easily and precisely.

According to an embodiment, the base film may be released by the conveying device upstream of the at least one centering pin in terms of the direction of transport, so that the base film has play for the alignment by the centering pin. It can be ensured that the centering pin can align the base film without stretching the base film. This may be especially important for hard films that are difficult to stretch. However, this may be advantageous even with easily stretchable films, since excessive stretching of the film and a concomitant local reduction of the film thickness can then be prevented, at least in part.

The conveying device preferably comprises clamping chains with clamping elements which hold the base film on both lateral sides in terms of the direction of transport for conveying the base film. The clamping elements may release the base film upstream of the at least one centering pin in terms of the direction of transport.

According to a further embodiment, the base film or the film composite (base film with top film sealed thereonto) may be severed, in particular severed completely, upstream of the at least one centering pin in terms of the direction of transport transversely to the direction of transport by use of a transverse cutting device. This facilitates alignment along the direction of transport by the centering pin, since the film section to be aligned may be movable independently of the trailing film section.

According to an advantageous embodiment, the transverse cutting device may be integrated into the cutting station or the sealing station. Cutting transversely to the direction of transport using the transverse cutting device may be expediently carried out prior to the alignment by the centering pin. The transverse cutting device can be integrated into the cutting station or the sealing station in such a manner that it shares drive devices of the cutting station or the sealing station. Alternatively, it would also be conceivable to provide the transverse cutting device as a separate station.

The invention also relates to a thermoforming packaging machine. The thermoforming packaging machine according to the invention may be designed, suitable and configured to perform the method according to the invention.

The thermoforming packaging machine comprises a forming station for forming packaging troughs into a base film by thermoforming, a loading path for filling the packaging troughs with products to be packaged, a sealing station for closing the filled packaging troughs by sealing a top film onto the base film, a cutting station for cutting out the filled packaging troughs from the film composite, and a conveying device for clocked conveyance of the base film along a direction of transport to the forming station, onward to the loading path, further onward to the sealing station and still onward to the cutting station. In addition, a punching tool may be provided for forming centering holes in the base film in a defined relative position to the packaging troughs. Furthermore, at least one centering pin may be present and configured to align the base film by engagement into the centering holes. Other aspects and advantages of the present invention will be apparent from the following detailed description of the preferred embodiments and the accompanying drawing figures.

### DESCRIPTION OF THE SEVERAL VIEWS OF THE DRAWINGS

In the following, an advantageous embodiment of the present invention will be explained in more detail making reference to a drawing, in which the individual figures show:

FIG. 1 is a schematic side view of one embodiment of a thermoforming packaging machine with a transverse cutting device in accordance with the present disclosure;

FIG. 2 is a schematic side view of another embodiment of a thermoforming packaging machine with a film release upstream of the sealing station and upstream of the cutting station in accordance with the present disclosure;

FIG. 3 is a schematic sectional view through one embodiment of a completed packaging station in accordance with the present disclosure; and

FIG. 4A is a partial schematic sectional view of one embodiment of a work station of thermoforming packaging machine in accordance with the present disclosure showing a first operating state of the packaging machine wherein the base film is being aligned in the work station;

FIG. 4B is a partial schematic sectional view of the work station of FIG. 4A showing a second operating state of the packaging machine wherein the base film is being aligned in the work station; and

FIG. 4C is a partial schematic sectional view of the work station of FIG. 4A showing a third operating state of the packaging machine wherein the base film is being aligned in the work station.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

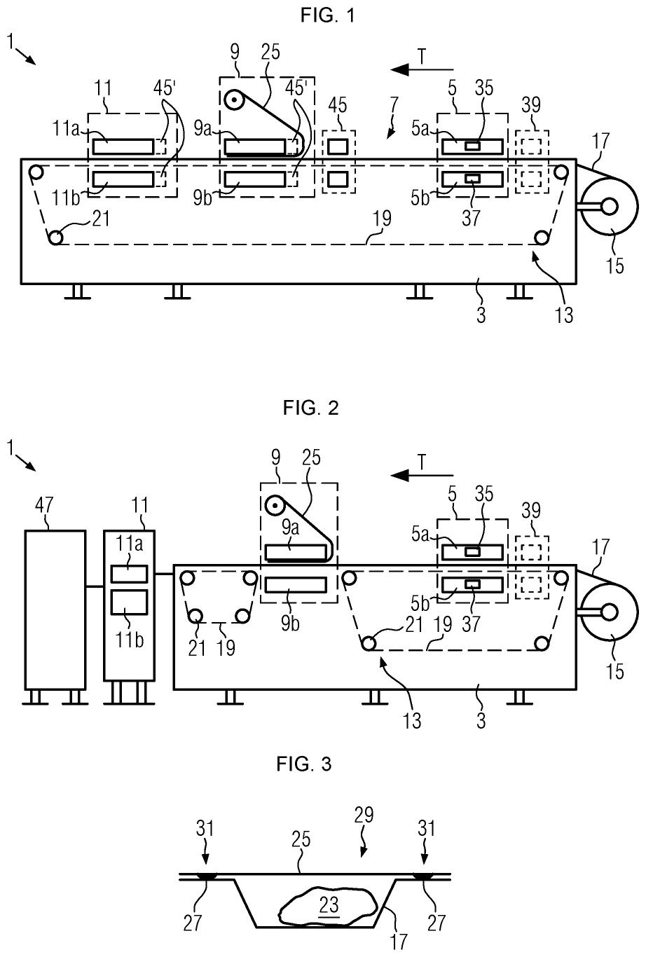

FIG. 1 shows a schematic side view of a thermoforming packaging machine 1 according to an embodiment. Thermoforming packaging machine 1 comprises a machine frame 3 on which a forming station 5, a loading path 7, a sealing station 9 and a cutting station 11 are arranged in a stationary manner along a direction of transport T. A conveying device 13 is provided for conveying a base film 17 withdrawn from a supply roll 15 along the direction of transport T to forming station 5, loading path 7, sealing station 9 and cutting station 11. Conveying device 13 comprises clamping chains 19 with clamping elements for holding base film 17 on both sides that are circulating on both lateral sides of machine frame 3 in terms of the direction of transport T. Conveying device 13 also comprises a drive device 21 for driving clamping chains 19. Clamping chains 19 are driven in such a way that base film 17 is conveyed in a clocked (intermittent) manner along the direction of transport T, wherein the working cycles of forming station 5, the sealing station 9 and the cutting station 11 are matched to one another.

Forming station 5 is designed to form packaging troughs into base film 17 by thermoforming. For this purpose, forming station 5 comprises a forming tool upper part 5a and a forming tool lower part 5b which can be moved relative thereto.

Products 23 to be packaged are inserted manually or automatically into the packaging troughs in loading path 7 which is downstream of forming station 5. The filled packaging troughs are sealed in sealing station 9 by sealingly connecting a top film 25 to base film 17. For this purpose, sealing station 9 comprises a forming tool upper part 9a and a forming tool lower part 9b which is movable relative thereto. In the illustrated embodiment, sealing tool lower part 9b moves upwardly during the sealing process toward sealing tool upper part 9a and engages therewith so that base film 17 and top film 25 present between sealing tool lower part 9b and sealing tool upper part 9a are sealed to each other along a sealing seam 27 (see FIG. 3). It would in principle also be conceivable for sealing tool upper part 9a to be lowered downwardly onto sealing tool lower part 9b, or that sealing tool upper part 9a and sealing tool lower part 9b both move

After sealing, the filled packaging troughs are cut out from the film composite in cutting station 11. This is preferably done by punching. In the illustrated embodiment, cutting station 11 comprises a cutting tool upper part 11a and a cutting tool lower part 11b which moves upwardly toward cutting tool upper part 11a for punching out packaging 29. However, it would also be conceivable for sealing tool upper part 11a to be lowered downwardly for the punching process onto sealing tool lower part 11a, or that sealing tool upper part 11a and sealing tool lower part 11b both move After the filled packaging troughs have been cut out from the film composite, the finished packaging's 29 can be removed manually or automatically.

FIG. 3 shows a schematic sectional view through an exemplary packaging 29. The latter comprises a trough-like lower part, which is formed from base film 17, and a top part closing the former and formed from top film 25. The lower part and the upper part are sealed together at a circumferential sealing seam 27. In the illustrated embodiment, the packaging 29 comprises a circumferential flange region 31 which comprises sealing seam 27.

In order to improve the positioning accuracy of base film 17 for certain processing steps, centering holes 33 are formed according to the invention in base film 17. In the illustrated embodiment, centering holes 33 are formed at the same time when the packaging troughs are formed in forming station 5. For this purpose, a punching tool is provided with a punching tool upper part 35 integrated into forming tool upper part 5a and a punching tool lower part 37 integrated into forming tool lower part 5b. Due to the fact that punching tool upper part 35 and punching tool lower part 37 are integrated into forming tool upper part 5a and forming tool lower part 5b, respectively, no separate drive is necessary for the punching tool. Centering holes 33 are then also formed in a particularly well-defined spatial relation to the packaging troughs, so that the position of the packaging troughs can later be adjusted particularly well by way of centering holes 33 during the centering process.

As shown in dashed lines in FIG. 1, however, it would also be conceivable not to integrate the punching tool into forming station 5, but to provide a separate punching station 39. As shown, the latter can be arranged upstream of forming station 5, or else be arranged in terms of the direction of transport T downstream of forming station 5.

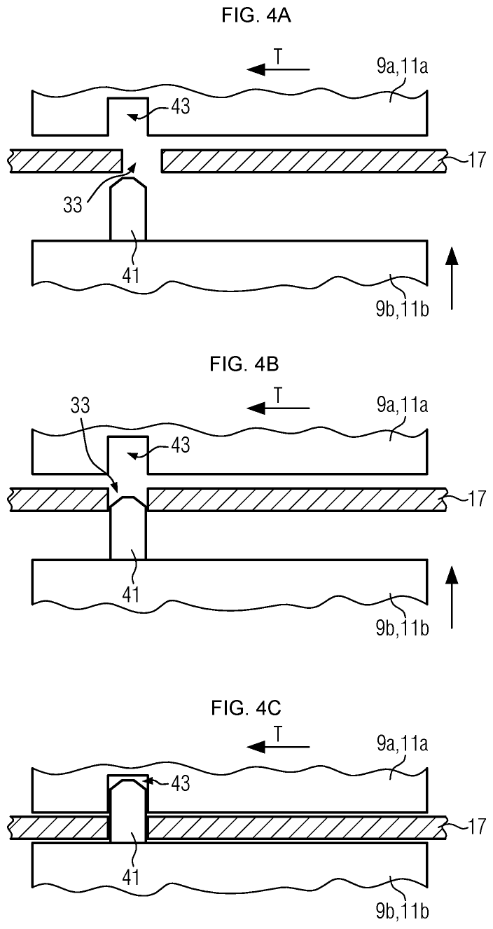

At least one centering pin 41 is provided in sealing station 9 and/or in cutting station 11 for engagement into a corresponding centering hole 33 in base film 17, thereby aligning base film 17 in a suitable manner. The alignment of base film 17 by centering pin 41 is shown schematically in FIGS. 4A-4C which illustrates temporally successive operating states in parts A, B and C. The sequence shown in FIGS. 4A-4C can relate to sealing station 9 as well as to cutting station 11. In the illustrated embodiment, centering pin 41 is provided on a respective tool lower part (sealing tool lower part 9b or cutting tool lower part 11b) and extends upwardly in the direction toward the corresponding tool upper part (sealing tool upper part 9a or cutting tool upper part 11a). Provided opposite to centering pin 41 is receiving recess 43 for centering pin 41 in corresponding tool upper part 9a, 11a. Only base film 17 is shown in FIGS. 4A-4C for the sake of clarity, while top film 25 located between base film 17 and tool upper part 9a, 11a is not shown.

In the situation shown in FIG. 4A, base film 17 is disposed displaced relative to a desired position along the direction of transport T prior to the beginning of the sealing process or of the cutting process, respectively, for example due to an advance tolerance of conveying device 13. From the opened operating state of sealing station 9 or cutting station 11 shown in in FIG. 4A, tool lower part 9b, 11b is raised upwardly along a vertical direction towards tool upper part 9a, 11a. During the raising process, centering pin 41 engages into a corresponding centering hole 33 of base film 17, as shown in FIG. 4B. By suitable choice of the diameter of centering holes 33 in dependence of the advance tolerance of conveying device 13 used, it can be achieved that centering pin 41 in the starting position does not have such a large displacement that no engagement takes place at all between centering pin 41 and centering hole 33. A certain basic accuracy of conveying device 13 is therefore advantageous, and in practice also quite feasible.

With the engagement of centering pin 41 into centering hole 33, base film 17 is aligned in a suitable manner. In the illustrated situation, base film 17 is pushed onward along the direction of transport T due to the engagement with centering pin 41. However, it would also be conceivable that base film 17 is pushed against the direction of transport T and/or laterally relative to the direction of transport T due to the engagement with centering pin 41. In order to facilitate the alignment of base film 17, centering pin 41 preferably has a shape that tapers towards its free end. After alignment of base film 17, tool lower part 9b, 11b is further moved upwardly (see FIG. 4C) to perform the sealing process or the cutting process, respectively. Centering pin 41 then dips into receiving recess 43 of tool upper part 9a, 11a and thereby does not hinder the sealing process or the cutting process, respectively.

In the illustrated embodiment, centering pin 41 is provided on tool lower part 9b, 11b. However, it would also be conceivable that centering pin 41 is provided on tool upper part 9a, 11a and corresponding receiving recess 43 for centering pin 41 is provided on tool lower part 9b, 11b.

Centering holes 33 preferably have a round cross section of the opening. But this is not mandatory. For example, rectangular or differently shaped cross sections of the opening would also be conceivable. Round, rectangular or other cross sections are also conceivable for centering pin 41. The shape of the cross section of centering pin 41 preferably corresponds to the shape of the cross section of the centering holes 33.

As explained, it is preferred to have the centering take place by use of a centering pin 41 in sealing station 9 and/or in the cutting station 11. In principle, however, it would also be conceivable to center base film 17 wherein by way of additional or alternative centering pins 41. It would even be conceivable to provide a separate centering station which could be, for example, upstream of sealing station 9 or cutting station 11.

In the embodiment shown in FIG. 1, a transverse cutting device 45 is provided which completely severs base film 17 or the film composite transversely to the direction of transport T forward of centering pin 41 in terms of the direction of transport T. In the illustrated embodiment, transverse cutting device 45 is provided upstream of sealing station 9 and upstream of cutting station 11. Severing base film 17 or the film composite transversely to the direction of transport T before it reaches centering pin 41 has the advantage that the severed part of base film 17 can be aligned freely by centering pin 41, substantially independently of the remaining part of base film 17. Stretching and thus thinning base film 17 during the alignment with centering pin 41 is then prevented.

As shown in dashed lines in FIG. 1, it would alternatively also be conceivable to integrate the transverse cutting device into sealing station 9 or into cutting station 11 (reference symbol 45′). The transverse cut could therefore be made directly prior to the alignment of base film 17 in sealing station 9 or in cutting station 11.

FIG. 2 shows an alternative embodiment of a thermoforming packaging machine 1. Like in the embodiment according to FIG. 1, centering holes 33 are formed in base film 17 and are then used in sealing station 9 and/or in cutting station 11 for aligning base film 17 by way of at least one centering pin 41. The basic mode of operation and also the description of individual elements can be transferred from the embodiment according to FIG. 1 to the embodiment according to FIG. 2. In order to avoid repetition, only features that differ from the embodiment shown in FIG. 1 shall be described with reference to FIG. 2.

No transverse cutting device is provided in the embodiment of FIG. 2. Instead, conveying device 13 releases base film 17 before it reaches sealing station 9 and again takes up base film 17 downstream of sealing station 9 in terms of the direction of transport T, in order to further convey base film 17. In the illustrated embodiment, conveying device 13 is separated for this purpose into a first part upstream of sealing station 9 in terms of the direction of transport T and a second part downstream of sealing station 9 in terms of the direction of transport T, wherein the first and the second part each comprise their own drive device 21. Due to the fact that base film 17 is not held in the region of sealing station 9 by clamping chains 19 of conveying device 13, there is a certain play for base film 17, so that base film 17 by can be easily aligned due to the interaction of centering pin 41 provided in sealing station 9 with a corresponding centering hole 31 in base film 17.

Cutting station 11 in the embodiment of FIG. 2 is formed as a separate cutting station 11, which is present separate from machine frame 3. Before reaching cutting station 11, conveying device 13 releases base film 17 again, so that base film 17 also has a certain play in the region of cutting station 11 in order to be aligned by way of a centering pin 41 provided in cutting station 11. Disposed downstream of cutting station 11 is a winding device 47 for the remaining film web, which is likewise present separate from machine frame 3.

As mentioned, it is not absolutely necessary for base film 17 to be centered by a centering pin 41 both in sealing station 9 as well as in cutting station 11. It is perfectly sufficient for many applications to have the centering by way of a centering pin 41 take place only in sealing station 9 or in cutting station 11. It would also be conceivable that the centering of base film 17 by centering pin 41 takes place only outside sealing station 9 and cutting station 11.

Different approaches have been described to provide base film 17 with play, so that it can be aligned more easily by centering pin 41. In particular, transverse cutting device 45, 45′ from FIG. 1 and the releasing process of base film 17 by conveying device 13 from FIG. 2 have been discussed in this context. However, the provision of these measures is not necessarily required in every case. In some applications, base film 17 can also be aligned by way of centering pin 41 without special measures being taken to provide additional play for base film 17. For example, base film 17 could simply be slightly stretched during the alignment. It would also be conceivable that base film 17 is transported with sufficient play anyway.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention.

As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for packaging products, the method comprising the steps of:
conveying a base film in a clocked manner using a conveying device along a direction of transport sequentially through a forming station, a loading path, a sealing station and a cutting station;
thermoforming packaging troughs into the base film in the forming station;
forming centering holes into the base film in a defined relative position to the packaging troughs;
filling the packaging troughs in the loading path with products;
sealing the filled packaging troughs in the sealing station by sealingly connecting a top film to the base film;
cutting out the filled packaging troughs from the film composite in the cutting station; and
aligning the base film by engaging at least one centering pin into the formed centering holes.

2. The method according to claim 1, wherein the aligning the base film step occurs in the cutting station.

3. The method according to claim 2, wherein the cutting step includes moving a cutting tool upper part and a cutting tool lower part relative towards each other to cut out the filled packaging troughs, wherein said aligning step occurs prior to or during the moving of the cutting tool upper part and the cutting tool lower part.

4. The method according to claim 1, wherein the aligning the base film step occurs in the sealing station.

5. The method according to claim 4, wherein the sealing step includes moving a sealing tool upper part and a sealing tool lower part of the sealing station relative towards each other for sealingly connecting the top film to the base film, wherein the aligning step occurs prior to or during the moving of the sealing tool upper part and the sealing tool lower part.

6. The method according to claim 1, wherein the forming the centering holes step occurs when the packaging troughs are formed in the forming station by punching the base film.

7. The method according to claim 1, further comprising the step of releasing the base film by the conveying device upstream of the at least one centering pin in the direction of transport so that the base film is capable to displace to be aligned by the centering pin.

8. The method according to claim 1, further comprising the steps of gripping the base film on both lateral sides of the base film using a plurality of clamping elements of a clamping chain disposed on each lateral side of the base film for conveying the base film, and releasing the base film by the conveying device upstream of the at least one centering pin in the direction of transport.

9. The method according to claim 1, further comprising the step of severing the base film transversely to the direction of transport upstream of the at least one centering pin in the direction of transport using a transverse cutting device.

10. The method according to claim 9, wherein the transverse cutting device is one of integrated into the cutting station or the sealing station, or is provided as a separate station.

11. A thermoforming packaging machine comprising:
a forming station for forming packaging troughs into a base film by thermoforming;
a punching tool for forming centering holes into the base film in a defined relative position to the packaging troughs;
a loading path for filling the packaging troughs with products to be packaged;
a sealing station for sealing the filled packaging troughs by sealingly connecting a top film to a base film;
a cutting station for cutting out the filled packaging troughs from the film composite; and
a conveying device for conveying of the base film in a clocked manner along a direction of transport to the forming station, onward to the loading path, further onward to the sealing station and again onward to the cutting station,
at least one centering pin disposed at one of the sealing station or the cutting station and being capable to align the base film by the engagement with the centering holes formed by the punching tool.
